(19) United States
(12) Patent Application Publication
(10) Pub. No.: US 2022/0122212 A1
(43) Pub. Date: Apr. 21, 2022

(54) RIDESHARE MANAGEMENT METHOD, DEVICE AND MOBILE APPLICATION WITH SELECTABLE DRIVER PROGRAMS

(71) Applicant: Sameh Mosa Kryakos, Orlando, FL (US)

(72) Inventor: Sameh Mosa Kryakos, Orlando, FL (US)

(21) Appl. No.: 17/504,717

(22) Filed: Oct. 19, 2021

Related U.S. Application Data
(60) Provisional application No. 63/094,625, filed on Oct. 21, 2020.

(51) Int. Cl. G06Q 50/30; G06F 3/0482; G06F 3/0484; H04L 29/08; G06Q 10/10; G06Q 10/06; G06Q 30/02

(52) U.S. Cl. CPC G06Q 50/30; G06F 3/0482; G06F 3/0484; H04L 67/141; H04W 88/02; G06Q 10/06375; G06Q 30/0206; G06Q 30/0284; G06Q 10/1053

(57) ABSTRACT

A method includes generating a GUI on a display with a selection from multiple driver income program options, controlling a mobile wireless communication interface to connect to a rideshare server to selectively display the multiple driver income program options, and provide for selection thereof, and receiving a driver input selecting a driver income program. Also, the selected driver income program and a time period associated therewith are displayed, a connection is made between the rideshare driver and the rideshare customer, and associated driver income is processed according to a selected driver income program. The method includes controlling the mobile wireless communication interface to connect to the rideshare server to display projected income based upon the selected driver income program over the time period and controlling the mobile wireless communication interface to connect to the rideshare server to display options for changing the selected driver income program.

### RELATED APPLICATIONS

This application claims priority under 35 U.S.C. § 119(e) of U.S. Provisional Patent Application Ser. No. 63/094,625 (Attorney Docket No. 5236.00001) filed on Oct. 21, 2020 and titled RIDESHARE APPLICATION WITH SELECTABLE DRIVER PROGRAMS AND ASSOCIATED METHODS, the content of which is incorporated herein by reference.

### FIELD OF THE INVENTION

The present invention relates to mobile applications, systems, devices and methods for ridesharing management.

### BACKGROUND

Ridesharing (also known as transportation networking or mobility servicing) matches passengers with vehicles, via websites and mobile apps. Ridesharing companies for automobiles, such as Uber and Lyft may be commonly referred to as ride-hailing services, and such companies exist for aircraft and watercraft as well. Ridesharing companies are examples of the sharing economy, the gig economy, and shared mobility.

Ridesharing companies have been noted for providing service in less populated or poorer areas that are not regularly served by taxicabs, and charging lower rates than taxicabs, since taxicab rates are often set by local jurisdictions.

However, there are many complaints about the low pay and lack of options for ridesharing drivers. There is a need for a ridesharing application with more options for the drivers to determine income.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

It is an object of the present embodiments to provide a method, system, device, mobile application and non-transitory computer readable medium for managing rideshare services with multiple driver income program options.

This and other objects, advantages and features in accordance with the present embodiments may be provided by a method of managing ridesharing services, between a rideshare administrator and a rideshare driver, on a mobile device that includes a processor, an associated touch screen display for receiving inputs from a user and for displaying information to the user, a memory for storing data and application instructions, and a mobile wireless communication interface for communicating over a wireless communication network. The method includes: generating a graphical user interface (GUI) on the display that provides for a selection from multiple driver income program options; controlling the mobile wireless communication interface to connect to a rideshare server, via the wireless communication network, to selectively display, on the GUI, the multiple driver income program options, and provide for selection from the multiple driver income program options via driver inputs; receiving a driver input associated with a selected driver income program from among the multiple driver income program options; operating the display to show the selected driver income program and a time period associated therewith; controlling the mobile wireless communication interface to communicate with a rideshare customer via the rideshare server, via the wireless communication network, to provide for connection of the rideshare driver and the rideshare customer and process associated driver income according to a selected driver income program; controlling the mobile wireless communication interface to connect to the rideshare server, via the wireless communication network, to display projected income based upon the selected driver income program over the time period; and controlling the mobile wireless communication interface to connect to the rideshare server, via the wireless communication network, to display options for changing the selected driver income program.

Additionally, and/or alternatively, various embodiments may include displaying time limits regarding changing the selected driver income program.

Additionally, and/or alternatively, various embodiments may include the multiple driver income program options having an option for payment of a one-time fee to the rideshare administrator over a time period and the driver earns fares during the time period. The one-time fee may vary based upon at least one factor including supply, demand, weather, vehicle quality, driver quality, and location.

Additionally, and/or alternatively, various embodiments may include the multiple driver income program options having an option for allocating payment of a first fare to the rideshare administrator for a time period, and the driver earns any other fares during the time period. The option may include allocating payment of a percentage of the first fare to the rideshare administrator when demand for rideshare services is high.

Additionally, and/or alternatively, various embodiments may include the multiple driver income program options having an option for allocating a commission rate for each fare over a time period. The multiple driver income program options may include an option for randomly selecting one of the multiple driver income programs.

Additionally, and/or alternatively, various embodiments may include operating the display to show a graphical indication of progress of the projected income.

Another embodiment is directed to a mobile device including a processor, an associated touch screen display, coupled to the processor, for receiving commands from a user and for displaying information to the user, a mobile wireless communication interface, coupled to the processor, for communicating across a wireless communication network with a rideshare administrator via a rideshare server, and a memory, coupled to the processor, for storing data and application instructions for execution on the processor. Execution of the instructions causes the processor to: generate a graphical user interface (GUI) on the display that provides for a selection from multiple driver income program options; control the mobile wireless communication interface to connect to the rideshare server, via the wireless communication network, to selectively display, on the GUI, the multiple driver income program options, and provide for selection from the multiple driver income program options via driver inputs; receive a driver input associated with a selected driver income program from among the multiple driver income program options; operate the display to show the selected driver income program and a time period associated therewith; control the mobile wireless communication interface to communicate with a rideshare customer via the rideshare server, via the wireless communication network, to provide for connection of the rideshare driver and the rideshare customer and process associated driver income according to a selected driver income program; and control the mobile wireless communication interface to connect to the rideshare server, via the wireless communication network, to display options for changing the selected driver income program.

Another embodiment is directed to a non-transitory computer readable medium including instructions to be executed by a processor of a mobile device that includes an associated touch screen display for receiving commands from a user and for displaying information to the user, a memory for storing data and application instructions for execution on the processor, and a mobile wireless communication interface for communicating across a communication network with a rideshare administrator via a rideshare server. Execution of the instructions causes the processor to: generate a graphical user interface (GUI) on the display that provides for a selection from multiple driver income program options; control the mobile wireless communication interface to connect to the rideshare server, via the wireless communication network, to selectively display, on the GUI, the multiple driver income program options, and provide for selection from the multiple driver income program options via driver inputs; receive a driver input associated with a selected driver income program from among the multiple driver income program options; operate the display to show the selected driver income program and a time period associated therewith; control the mobile wireless communication interface to communicate with a rideshare customer via the rideshare server, via the wireless communication network, to provide for connection of the rideshare driver and the rideshare customer and process associated driver income according to a selected driver income program; and control the mobile wireless communication interface to connect to the rideshare server, via the wireless communication network, to display options for changing the selected driver income program.

### BRIEF DESCRIPTION OF THE DRAWINGS

The figures which accompany the written portion of this specification illustrate embodiments and method(s) of use according to the teachings of the present invention.

FIG. 1 shows a schematic block diagram illustrating a communication system including ridesharing connectivity on a mobile electronic device according to an embodiment of the present invention.

FIG. 2 is a schematic block diagram illustrating the components of the mobile device according to an embodiment of the present invention of FIG. 1.

FIG. 3 is front view illustrating the mobile device including ridesharing driver program option selections according to an embodiment of the present invention of FIG. 1.

FIG. 4 is another front view illustrating a mobile device with ridesharing driver program option selections according to an embodiment of the present invention of FIG. 1.

FIG. 5 is a flowchart illustrating a method of managing ridesharing services, between a rideshare administrator and a rideshare driver, on a mobile device according to an embodiment of the present invention of FIGS. 1-4.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will appreciate that the following descriptions of the embodiments of the present invention are illustrative and are not intended to be limiting in any way. Other embodiments of the present invention will readily suggest themselves to such skilled artisans having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

As discussed above, embodiments of the present invention relate to ridesharing and more particularly to a method, mobile device and application used to improve driver income options and capabilities.

Generally, depending on the type of wireless communication system, a wireless communication device or mobile device, such as a smartphone, cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

The present embodiments are generally directed to a ridesharing approach that provides drivers with the capability to selectively choose one or more of various income programs.

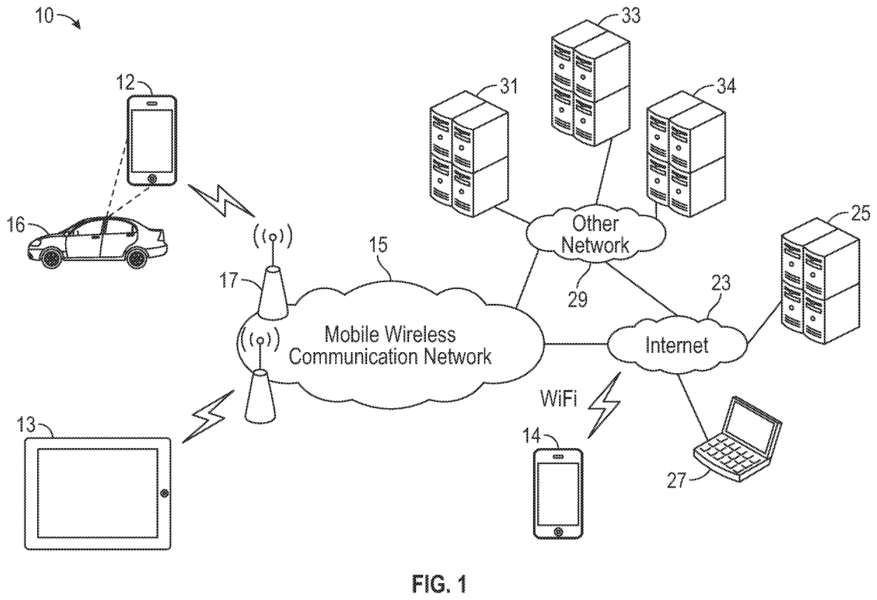

FIG. 1 illustrates a system 10 offering a variety of mobile communication services, including communications in support of providing ridesharing communications for users' mobile devices. The example shows three mobile devices 12, 13, and 14 as well as a mobile wireless communication network 15. The devices 12-14 are examples of mobile devices that may execute an application configured to provide the ridesharing functionality. The network 15 provides mobile wireless communications services to those devices as well as to other mobile devices via several base stations 17. The present techniques may be implemented in any of a variety of available mobile networks 15 and/or on any type of mobile devices compatible with such a network 15.

Some mobile devices 12-14 may be operative to communicate using a variety of communication networks and protocols other than those used for communication through the mobile wireless network 15. For example, as shown for device 14, at least some mobile devices are additionally or alternatively configured for data communication through a wireless communication link such as a Wi-Fi link. Mobile devices communicating through Wi-Fi communication links may access Internet-connected servers and services directly through the Internet 23, and/or access servers and services provided by a carrier of the mobile wireless network 15 via the Internet 23 and a private network 29 operated by the carrier.

The wireless mobile communication network 15 may include one or more wired and/or wireless networks or connections. For example, network 15 may include a cellular network (e.g., a long-term evolution (LTE) network, a 5G network, or a code division multiple access (CDMA) network), a public land mobile network (PLMN), a local area network (LAN) (e.g., a Wi-Fi network), a wide area network (WAN), a metropolitan area network (MAN), a telephone network (e.g., the Public Switched Telephone Network (PSTN)), a private network, an ad hoc network, a wired connection, a wireless connection (e.g., a Bluetooth connection or a nearfield communication connection), or the like, and/or a combination of these or other types of networks or connections.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

The mobile devices 12-14 are capable of data communications through the network 15, and some devices may additionally be capable of voice telephone communications through the network 15. Mobile device 12, as illustrated, is being used by a driver of a vehicle 16. The driver may be using the vehicle 16 to provide ridesharing to customers via a ridesharing company that offers various driver income program options as will be discussed in detail below.

The network 15 typically offers a variety of data services via the Internet 23, such as downloads, web browsing, email, etc. As illustrated, there is shown a laptop PC type user terminal 27 as well as a server 25 connected to the Internet 23; and the data services for the mobile devices 12-14 via the Internet 23 may be with such devices or any other type of device or system capable of data communications through the various interconnected networks. Data services for the mobile devices 12-14 can additionally be routed directly to the Internet 23 through other types of communication links, such as Wi-Fi links, in situations in which the mobile devices 12-14 are configured for communications across and have access to such links. The mobile devices 12-14 of users can receive or download software applications through the networks 23 and/or 15, such as application and/or other applications, and execute the applications written in various programming languages.

Mobile devices 12-14 can be portable handsets, smartphones, or personal digital assistants, although they may be implemented in other forms. For example, mobile devices 12-14 can be tablet computers, such as iPads, or other computing devices configured for communication through a mobile wireless communication network 15 and/or other types of wireless communication links. Program applications, including the present ridesharing application, can be configured to execute on many different types of mobile devices 12-14. For example, a mobile device application can be written to execute on a Windows Mobile based mobile device, Android, iPhone, Java Mobile, or Blackberry based mobile device, for example.

The mobile communication network 15 can be implemented by several interconnected networks. Hence, the overall network 15 may include several radio access networks, as well as regional ground networks and a wide area network (WAN) interconnecting the regional ground networks to core network elements. Physical elements operated by one of the mobile service providers or carriers include several base stations represented in the example by the base stations 17. A base station 17 can include a base transceiver system, which can communicate via an antenna system at the site of the base station and over the air link with one or more of the mobile devices 12-14, when the mobile devices are within range. Each base station can be coupled to several antennas mounted on a radio tower within a coverage area.

A mobile device 12-14 communicates over the air with a base station 17 and through the mobile wireless network 15 for various voice and data communications, e.g. services provided by an Internet-connected server 25 and/or application servers 31, 33, 34.

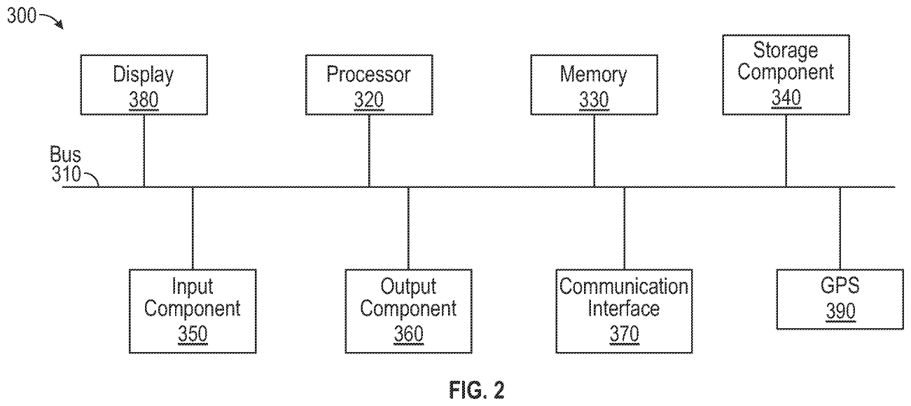

Referring additionally to FIG. 2, an embodiment of a mobile device 300, such as mobile devices 12-14 of FIG. 1, including a ridesharing capability in accordance with features of the present invention will be described. FIG. 2 is a diagram of example components of a device 300. Device 300 may correspond to mobile device 12, 13 or 14. As shown in FIG. 2, device 300 may include a bus 310, a processor 320, a memory 330, a storage component 340, an input component 350, an output component 360, a communication interface 370, a display 380 and Global Positioning System (GPS) component.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include various computer memory types such as RAM, DRAM, SDRAM, DDR, GDDR, HBM, ROM, PROM, EPROM, EEPROM, NVRAM a hard disk (e.g., a magnetic disk, an optical disk, a magneto-optic disk, a solid state disk, etc.), a compact disc (CD), a digital versatile disc (DVD), a floppy disk, a cartridge, a magnetic tape, an SSD, and/or another type of non-transitory computer-readable medium, along with a corresponding drive.

Input component 350 may include a component that permits device 300 to receive information, such as via user input (e.g., components of a touch screen display, a keyboard, a keypad, a mouse, a button, a switch, a microphone, etc.). Additionally, or alternatively, input component 350 may include a sensor for sensing information (e.g., a geo-location module such as a global positioning system (GPS) component, an accelerometer, a gyroscope, an actuator, etc.). Output component 360 may include a component that provides output information from device 300 (e.g., a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Display 380 may be a digital display, for example, an LCD, LED, plasma display, touch screen or any other digital display capable of communicating information including displaying text, graphics, images, video, maps, AR/VR, etc.

GPS 390 may provide location and tracking capabilities to the processor 320 for display of maps and navigation graphics on the display 380, or audio directions to the output component 360, as would be appreciated those skilled in the art.

Device 300 may perform one or more processes described herein. Device 300 may perform these processes in response to processor 320 executing software instructions stored by a non-transitory computer-readable medium, such as memory 330 and/or storage component 340. A computer-readable medium may be defined herein as a non-transitory medium or memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 300 may include additional components, fewer components, different components, or differently arranged components than those shown in FIG. 2. Additionally, or alternatively, a set of components (e.g., one or more components) of device 300 may perform one or more functions described as being performed by another set of components of device 300.

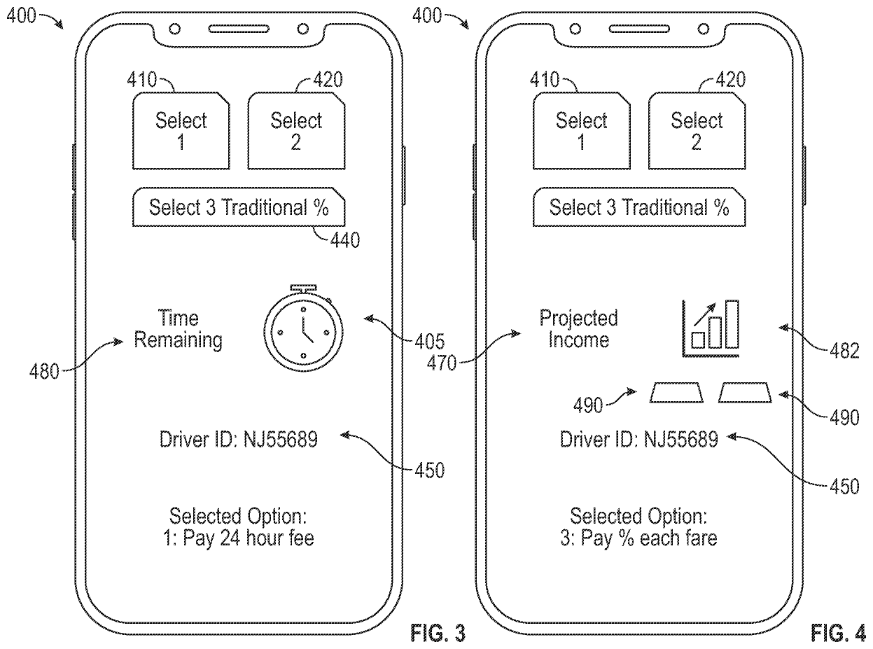

Referring additionally to FIGS. 3 and 4, there are shown front views of a smartphone 400, which may be an example of the mobile devices 12-14 of FIG. 1, and device 300 of FIG. 2. The smartphone 400 has installed thereon (e.g. in the memory 330 or storage component 340), a ridesharing application that provides for capabilities for a driver to select at least one income program option for specific purposes on such a portable device. The application includes instructions to be executed by the processor 320.

Execution of the instructions causes the processor 320 to: generate a graphical user interface (GUI) 405 on the display 380 that provides for the selection of various driver income program options; control the mobile wireless communication interface 370 to connect to a rideshare server (e.g. server 25), via the wireless communication network 15, to selectively display various income program options, and provide for selection of the income program options e.g. via input 410, via input 420, or input 440, for example; control the mobile wireless communication interface 370 to communicate with a rideshare customer via the rideshare server (e.g. server 25), via the mobile wireless communication network 15, to provide for connection of the driver and rider using the rideshare system (e.g. provided by the rideshare company) and processing the driver income according to the selected driver income program option; operating the display 380 to show the selected driver income program option (e.g. option 1 “Pay a single fee in advance for a 24 hour period and keeping any other fares earned during the time period”); operate the display 380 to show the time remaining 480 for the selected option; control the mobile wireless communication interface 370 to connect to the rideshare server (e.g. server 25), via the mobile wireless communication network 15, to display projected income 482 using the selected driver income program option; and control the mobile wireless communication interface 370 to connect to the rideshare server (e.g. server 25), via the mobile wireless communication network 15, to display options 490 for changing the selected driver income program option. There may be time limits or other limitations regarding when a driver can change the selected option and/or which options are still available.

The driver income program options and other example features of the rideshare application, method and system will now be described. An object of the approach is to provide the drivers with more options to earn income. The first option 410 may be a one-time charge (e.g. paid in advance) for the driver for a time period, then the driver keeps the earned fares/fees for the remaining time period. For example, the first $25 may be allocated to the rideshare company and then the rest of fares earned goes to the driver. This fee may be adjustable based upon factors such as supply, demand, weather, vehicle quality, driver quality, location (city, county, state, country) etc. The one-time fee could be daily, weekend, weekly, monthly etc. For example, the fee may be $75 for the week, or $250 for the month. All other options are available and contemplated. Also, it may be possible to allow the one-time fee to be paid over a number of rides/fares, but then it may be a higher amount.

A second option 420 may include allocating the full payment of the first trip/fare value to the company (e.g. only once per day or 24-hour period). The rest of the income from fares is entirely allocated to the driver during this time period or day. The amount of the fare for the first run in this selection may be unknown to the driver, so there may be a risk allocated to the driver. Also, the rideshare company may make offers, for example, by allocating only a percentage (e.g. 25%, 50%, or 75%) of the value of the first fare to entice drivers, for example, when demand is high. This may be an offer made for higher quality drivers, or according to the company needs at that time.

The third option 440 may be similar to typical income programs for existing companies in this field. They pay a commission rate for each trip that the driver makes, and it is determined according to the price of each trip separately. The company may make offers such as paying an amount related to each transaction, as it may be a percentage, fixed price, or variable rate, as the company's needs demand. Again, this may be an offer made for higher quality drivers, or according to the company needs at that time.

Yet another option of the inventive rideshare approach may allow for the driver to participate in a “game” to determine which option will be used to compensate the driver for a particular time period. For example, the driver may be prompted to participate in the “game” upon signing on to start taking fares. The game is a game of chance and in some instances, the game may provide a result that is very favorable to the driver, e.g., the driver may only have to pay 10% of the one fee set forth in the first option 410. More specifically, and for exemplary purposes only, if the fee for a 24-hour period of driving is set in a particular geographical location to $25 and the driver engages in the game, the result of the game may be that the driver only has to pay 10% of the fee set forth in the first option 410, e.g., $2.50. Similarly, however, the game of chance may yield a result that is more favorable to the company, e.g., the driver will have to pay 150% of the fee, e.g., $37.50.

Other features of the inventive rideshare approach may include charging a fixed fee (e.g. approximately $1) for insurance for each rideshare trip by the customer. Also, the customer may be charged a tax, and/or an amount or percentage (e.g. 2.5%) as a credit. In the future (e.g. based upon the number of rides, or spending amounts) a portion or all-of this credit may be allocated (e.g. as a reward or bonus in the future) or returned to the customer, and a portion may be allocated to the driver, as may be determined. In the future, the driver or the customer may access their credits for use towards fares or fees, for example.

Of course, any taxes or government fees may be obtained or deducted from the customer fare for the benefit of the authorities in charge of deduction and collection. An example of a fare may allocate $10.00 for the driver, tax $0.65, insurance $1.00, and credit or bonus $0.25. Tolls for the route may also be included, e.g. $0.10. So, the total of $12.00 may be charged to the customer, and the amount is paid in full via credit card or account balance, for example.

Of course, like other rideshare companies in this field, prices may vary by the type of car. There may be quality levels, for example bronze (regular mini cars), the second is silver (large ordinary cars), the third is gold (e.g. SUVs) and the fourth “Diamond” (e.g. luxury cars).

The driver may have the right to navigate the options whenever he/she wants. The company may create icons 490 in the program GUI 405 to allow the driver to change at any time, thus starting the time period (e.g. twenty-four-hour countdown 480) again, and starting another time period after the new selection.

The rideshare server may be defined by a single computer, server cluster and/or network appliance that is operated by a ridesharing administrator at a ridesharing company or any other industry related organization that handles ridesharing management as would be appreciated by those skilled in the art.

In various embodiments, selectively by the driver may include requesting input of a security verification, such as password verification and/or two-step authentication. Requesting input of the security verification may include requesting input of a biometric verification including the use of a fingerprint recognition, facial recognition, retinal recognition, iris recognition and/or voice recognition, for example, as would be appreciated by those skilled in the art. A unique driver ID 450 may also be displayed.

In certain embodiments, the approach may include operating the display 380 to show progress of projected income 470 over the time period, as illustrated in FIG. 4. Also, operating the display to show progress of the projected income 470 may include displaying a graphical indication 482 of the progress of the selected driver income program.

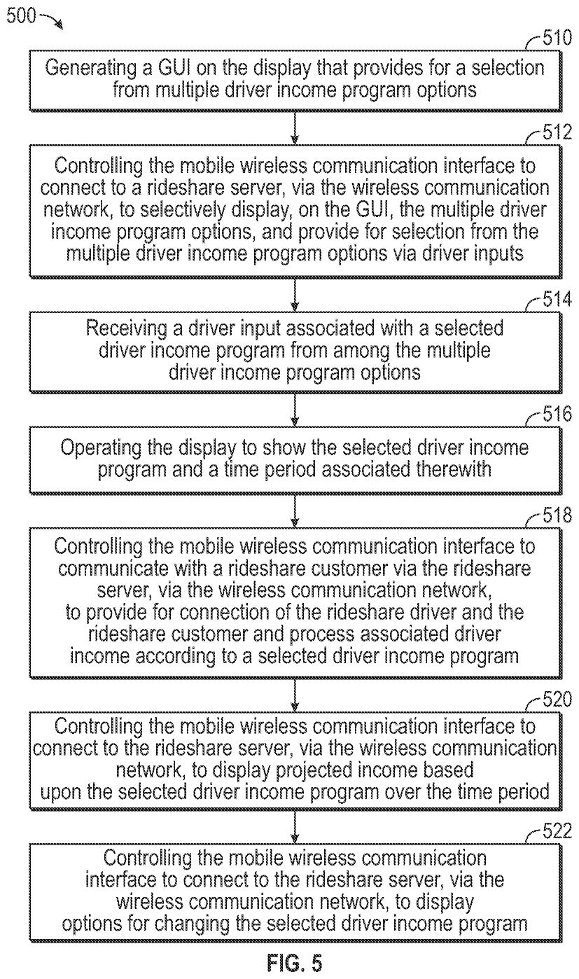

FIG. 5 is a flowchart illustrating a method 500 of managing ridesharing services, between a rideshare administrator and a rideshare driver, on a mobile device 12-14 according to an embodiment of the present invention. The method 500 includes: generating (block 510) a graphical user interface (GUI) 405 on the display 380 that provides for a selection from multiple driver income program options 410, 420, 440; controlling (block 512) the mobile wireless communication interface 370 to connect to a rideshare server (e.g. server 25), via the wireless communication network 15, to selectively display, on the GUI 405, the multiple driver income program options, and provide for selection from the multiple driver income program options via driver inputs; receiving (block 514) a driver input associated with a selected driver income program from among the multiple driver income program options 410, 420, 440; operating (block 516) the display 380 to show the selected driver income program and a time period 480 associated therewith; controlling (block 518) the mobile wireless communication interface 370 to communicate with a rideshare customer via the rideshare server (e.g. server 25), via the wireless communication network 15, to provide for connection of the rideshare driver and the rideshare customer and process associated driver income according to a selected driver income program; controlling (block 520) the mobile wireless communication interface 380 to connect to the rideshare server, via the wireless communication network 15, to display projected income 470 based upon the selected driver income program over the time period 480, for example displaying a graphical indication 482 of progress of the projected income; and controlling (block 522) the mobile wireless communication interface 380 to connect to the rideshare server, via the wireless communication network 15, to display options 490 for changing the selected driver income program.

The method may include displaying time limits regarding changing the selected driver income program. The multiple driver income program options may have an option 410 for payment of a one-time fee to the rideshare administrator over a time period 480 and the driver earns fares during the time period. The one-time fee may vary based upon at least one factor including supply, demand, weather, vehicle quality, driver quality, and location. The multiple driver income program options may include an option 420 for allocating payment of a first fare to the rideshare administrator for a time period 480, and the driver earns any other fares during the time period. The option 420 may include allocating payment of a percentage of the first fare to the rideshare administrator when demand for rideshare services is high. An option 440 may be for allocating a commission rate for each fare over a time period 480. The multiple driver income program options may include an option for randomly selecting one of the multiple driver income programs.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Users may download an application on their mobile phones, tablets or any other mobile computing device, and even a vehicle.

The foregoing disclosure provides illustration and description but is not intended to be exhaustive or to limit the implementations to the precise form disclosed. Modifications and variations are possible considering the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

1. A method of managing ridesharing services between a rideshare administrator and a rideshare driver on a mobile device that includes a processor, an associated touch screen display for receiving inputs from a user and for displaying information to the user, a memory for storing data and application instructions, and a mobile wireless communication interface for communicating over a wireless communication network, the method comprising:
generating a graphical user interface (GUI) on the display that provides for a selection from multiple driver income program options;
controlling the mobile wireless communication interface to connect to a rideshare server, via the wireless communication network, to selectively display, on the GUI, the multiple driver income program options, and provide for selection from the multiple driver income program options via driver inputs;
receiving a driver input associated with a selected driver income program from among the multiple driver income program options;
operating the display to show the selected driver income program and a time period associated therewith;
controlling the mobile wireless communication interface to communicate with a rideshare customer via the rideshare server, via the wireless communication network, to provide for connection of the rideshare driver and the rideshare customer and process associated driver income according to a selected driver income program;
controlling the mobile wireless communication interface to connect to the rideshare server, via the wireless communication network, to display projected income based upon the selected driver income program over the time period; and
controlling the mobile wireless communication interface to connect to the rideshare server, via the wireless communication network, to display options for changing the selected driver income program.

2. The method of claim 1, wherein displaying options for changing the selected driver income program includes displaying time limits regarding changing the selected driver income program.

3. The method of claim 1, wherein the multiple driver income program options include an option for payment of a one-time fee to the rideshare administrator over a time period and the driver earns fares during the time period.

4. The method of claim 3, wherein the one-time fee varies based upon at least one factor including supply, demand, weather, vehicle quality, driver quality, and location.

5. The method of claim 1, wherein the multiple driver income program options include an option for allocating payment of a first fare to the rideshare administrator for a time period, and the driver earns any other fares during the time period.

6. The method of claim 5, wherein the option includes allocating payment of a percentage of the first fare to the rideshare administrator when demand for rideshare services is high.

7. The method of claim 1, wherein the multiple driver income program options include an option for allocating a commission rate to the driver for each fare over a time period.

8. The method of claim 1, wherein the multiple driver income program options include an option for randomly selecting one of the multiple driver income programs.

9. The method of claim 1, wherein displaying projected income based upon the selected driver income program over the time period includes operating the display to show a graphical indication of progress of the projected income.

10. A mobile device comprising:
a processor;
an associated touch screen display, coupled to the processor, for receiving commands from a user and for displaying information to the user;
a mobile wireless communication interface, coupled to the processor, for communicating across a wireless communication network with a rideshare administrator via a rideshare server, and
a memory, coupled to the processor, for storing data and application instructions for execution on the processor, wherein execution of the instructions causes the processor to:
generate a graphical user interface (GUI) on the display that provides for a selection from multiple driver income program options;
control the mobile wireless communication interface to connect to the rideshare server, via the wireless communication network, to selectively display, on the GUI, the multiple driver income program options, and provide for selection from the multiple driver income program options via driver inputs;
receive a driver input associated with a selected driver income program from among the multiple driver income program options;
operate the display to show the selected driver income program and a time period associated therewith;
control the mobile wireless communication interface to communicate with a rideshare customer via the rideshare server, via the wireless communication network, to provide for connection of the rideshare driver and the rideshare customer and process associated driver income according to a selected driver income program; and
control the mobile wireless communication interface to connect to the rideshare server, via the wireless communication network, to display options for changing the selected driver income program.

11. The system of claim 10, wherein displaying options for changing the selected driver income program includes displaying time limits regarding changing the selected driver income program.

12. The system of claim 10, wherein the multiple driver income program options include an option for payment of a one-time fee to the rideshare administrator over a time period and the driver earns fares during the time period; and wherein the one-time fee varies based upon at least one factor including supply, demand, weather, vehicle quality, driver quality, and location.

13. The system of claim 10, wherein the multiple driver income program options include an option for allocating payment of a first fare to the rideshare administrator for a time period, and the driver earns any other fares during the time period; and wherein the option includes allocating payment of a percentage of the first fare to the rideshare administrator when demand for rideshare services is high.

14. The system of claim 10, wherein displaying projected income based upon the selected driver income program over the time period includes operating the display to show a graphical indication of progress of the projected income.

15. A non-transitory computer readable medium including instructions to be executed by a processor of a mobile device that includes an associated touch screen display for receiving commands from a user and for displaying information to the user, a memory for storing data and application instructions for execution on the processor, and a mobile wireless communication interface for communicating across a communication network with a rideshare administrator via a rideshare server, wherein execution of the instructions causes the processor to:
generate a graphical user interface (GUI) on the display that provides for a selection from multiple driver income program options;
control the mobile wireless communication interface to connect to the rideshare server, via the wireless communication network, to selectively display, on the GUI, the multiple driver income program options, and provide for selection from the multiple driver income program options via driver inputs;
receive a driver input associated with a selected driver income program from among the multiple driver income program options;
operate the display to show the selected driver income program and a time period associated therewith;
control the mobile wireless communication interface to communicate with a rideshare customer via the rideshare server, via the wireless communication network, to provide for connection of the rideshare driver and the rideshare customer and process associated driver income according to a selected driver income program; and
control the mobile wireless communication interface to connect to the rideshare server, via the wireless communication network, to display options for changing the selected driver income program.

16. The non-transitory computer readable medium of claim 15, wherein displaying options for changing the selected driver income program includes displaying time limits regarding changing the selected driver income program.

17. The non-transitory computer readable medium of claim 15, wherein the multiple driver income program options include an option for payment of a one-time fee to the rideshare administrator over a time period and the driver earns fares during the time period; and wherein the one-time fee varies based upon at least one factor including supply, demand, weather, vehicle quality, driver quality, and location.

18. The non-transitory computer readable medium of claim 15, wherein the multiple driver income program options include an option for allocating payment of a first fare to the rideshare administrator for a time period, and the driver earns any other fares during the time period; and wherein the option includes allocating payment of a percentage of the first fare to the rideshare administrator when demand for rideshare services is high.

19. The non-transitory computer readable medium of claim 15, wherein displaying projected income based upon the selected driver income program over the time period includes operating the display to show a graphical indication of progress of the projected income.

20. The non-transitory computer readable medium of claim 15 wherein the multiple driver income program options include an option for allocating a commission rate to the driver for each fare over a time period; and wherein the multiple driver income program options include an option for randomly selecting one of the multiple driver income programs.
